(19) United States
(12) Patent Application Publication
(10) Pub. No.: US 2019/0054463 A1
(43) Pub. Date: Feb. 21, 2019

(54) DEVICE FOR CAPILLARY FORCE SAMPLE LOADING AND IMPROVED ASSAY PERFORMANCE

(71) Applicant: AdvanDx, Inc., Woburn, MA (US)

(72) Inventors: Martin Fuchs, Uxbridge, MA (US); Melissa Ricci, Belmont, MA (US)

(21) Appl. No.: 16/031,794

(22) Filed: Jul. 10, 2018

Related U.S. Application Data
(63) Continuation of application No. PCT/US2017/013005, filed on Jan. 11, 2017.
(60) Provisional application No. 62/277,196, filed on Jan. 11, 2016.

(51) Int. Cl. B01L 3/00; G02B 21/34

(52) U.S. Cl. CPC B01L 3/50853; B01L 3/5088; G02B 21/34; G02B 21/16; B01L 2300/12; B01L 2300/0822; B01L 2300/165; B01L 2200/025

(57) ABSTRACT

Embodiments include devices and methods that enable loading of a fluid sample by capillary action and provide for subsequent thinning of the fluid layer for imaging of a processed sample. A device includes a substrate, a transparent cover, and one or more pillars separating the transparent cover from the substrate where the height of the one or more pillars sets a spacing between the transparent cover and the substrate prior to introduction of a fluid sample to the device. The one or more pillars may be soluble in aqueous fluids and/or soluble in a component of the fluid sample. The spacing between the substrate and the transparent cover may be configured to draw the fluid sample into a space between the substrate and the transparent cover via capillary forces.

### CROSS-REFERENCE TO RELATED APPLICATIONS

This application is a continuation of International Application No. PCT/US2017/013005, filed Jan. 11, 2017, which claims the benefit of U.S. Provisional Application Ser. No. 62/277,196 filed Jan. 11, 2016, the entire disclosures of both of which are expressly incorporated herein by reference.

### FIELD

Embodiments pertain to the field of devices and methods for performing assays and tests that are visualized with a microscope or other optical instrumentation.

### BACKGROUND

Microscopic analysis is widely used in biology and medicine to examine a wide range of samples ranging from fluids to tissue sections and other solids. Fluid samples often contain cells or cellular components in a biological matrix. For example, a sample might contain microorganisms in a clinical specimen. The identification of microbial species in clinical samples is necessary to direct the selection of appropriate therapy. Fluorescence In Situ Hybridisation (FISH) assays are well suited for species specific identifications, or class specific identifications. FISH assays can be performed with probes such as DNA, Peptide Nucleic Acid (PNA), or Locked Nucleic Acid (LNA) probes or combinations thereof. Current DNA, PNA or LNA FISH technology is limited by the need to fix the blood culture sample on the slide. This makes DNA, PNA or LNA FISH assays somewhat labor intensive.

### SUMMARY

One aspect of the invention pertains to a device including a substrate, a transparent cover, and one or more pillars separating the transparent cover from the substrate. The height of the one or more pillars sets a spacing between the transparent cover and the substrate prior to introduction of a fluid sample to the device.

In one embodiment, the one or more pillars are soluble in aqueous fluids. In one embodiment, the one or more pillars are soluble in a component of the fluid sample.

In one embodiment, the spacing between the substrate and the transparent cover is configured to draw the fluid sample into a space between the substrate and the transparent cover via capillary forces.

In one embodiment, the average spacing between the substrate and the transparent cover falls in the range of 40 to 95 microns. In one embodiment, the average spacing between the substrate and the transparent cover falls in the range of 40 to 85 microns. In another embodiment, the average spacing between the substrate and the transparent cover falls in a range of 64 to 78 microns. In some embodiments the average spacing between the substrate and the transparent cover falls in the range of 40 to 60 microns. In some embodiments, the average spacing between the substrate and the transparent cover falls in the range of 40-55 microns. In some embodiments, the average spacing between the substrate and the transparent cover falls in the range of 45-50 microns.

In one embodiment, the one or more pillars attach the transparent cover to the substrate prior to introduction of the fluid sample to the device.

In another embodiment, the one or more pillars include sucrose. In one embodiment, the one or more pillars include a low molecular weight water-soluble polymer. In one embodiment, the one or more pillars include a low molecular weight water-soluble polymer and a water-miscible liquid. In one embodiment, the low molecular weight water-soluble polymer includes a low molecular weight polyvinyl alcohol. In one embodiment, the water-miscible liquid includes a liquid with a high boiling point, a liquid with a low vapor pressure, or a liquid with both a high boiling point and a low vapor pressure. In one embodiment, the water-miscible liquid includes a plasticizer. In one embodiment, the water miscible liquid includes glycerol. In one embodiment, the water miscible liquid includes a phosphorus-containing molecule. In one embodiment, the water miscible liquid includes glycerol and a phosphorous-containing molecule. In another embodiment, the water miscible liquid includes a trialkyl phosphate. In another embodiment, the water miscible liquid includes polyphosphoric acid.

In one embodiment, the device includes a hydrophobic layer deposited on a top surface of the substrate where the hydrophobic layer includes a hydrophobic material and the transparent cover at least partially covers the hydrophobic layer. In one embodiment, the hydrophobic layer includes a cutout defining a sample loading area on the top surface of the substrate, the sample loading area partially covered by the transparent cover and extending beyond the transparent cover.

In one embodiment, the device is for analyzing a sample and the hydrophobic layer includes one or more cutouts defining one or more testing areas on the top surface of the substrate covered by the transparent cover.

In one embodiment, the device is for analyzing a sample and includes a first reagent disposed at one or more of the one or more testing areas. In another embodiment, the device also includes a second reagent different than the first reagent with the first reagent disposed at a first testing area of the one or more testing areas and the second reagent disposed at a second testing area of the one or more testing areas.

In one embodiment, the device is for analyzing a sample and further includes a first reagent disposed at a first testing area on the top surface of the substrate covered by the transparent. In another embodiment, the device also includes a second reagent different than the first reagent disposed at a second testing area on the top surface of the substrate covered by the transparent cover.

In one embodiment, the device is for analyzing a sample and further includes one or more reagents disposed at one or more testing areas on the top surface of the substrate covered by the transparent cover. In one embodiment, the one or more reagent are a plurality of reagents with each of the plurality of reagents disposed in a different test area. In one embodiment, the one or more reagents include DNA, PNA or LNA probes. In one embodiment, the one or more reagents are binding agents that bind to at least one microorganism.

In one embodiment, each test area includes a first layer of water soluble polymer including one or more of the reagents and a second layer of water soluble polymer covering the first layer of water soluble polymer. In one embodiment, the second layer of water soluble polymer is more hydrophobic than the first layer of water soluble polymer. In one embodiment, the first layer of water soluble polymer includes a hydrophilic polymer. In one embodiment, the first water soluble polymer includes poly (vinyl alcohol). In one embodiment, the second water soluble polymer includes polyethylene oxide.

In one embodiment of the device, the one or more pillars include at least 3 pillars. In another embodiment, the one or more pillars include at least 4 pillars. In one embodiment, the one or more pillars include at least 5 pillars. In another embodiment, the one or more pillars include at least 6 pillars. In another embodiment, the one or more pillars include at least 8 pillars. In another embodiment, the one or more pillars include at least 9 pillars. In another embodiment, the one or more pillars include at least 10 pillars.

In some embodiments, the one or more pillars include a plurality of peripheral pillars disposed in a peripheral area of the device and at least one interior pillar disposed in an interior area of the device.

In one embodiment of the invention, the substrate includes a slide and the transparent cover includes a cover slip. In one embodiment, one or both of the substrate and the transparent cover include a glass. In another embodiment, one or both of the substrate and the transparent cover include a low fluorescent plastic.

Another aspect of the invention pertains to a method for performing an analysis on a fluid sample without performing a fixation step. The method includes providing any of the devices described herein. The method also includes loading the fluid sample into the device by depositing the fluid sample on a top surface of the substrate adjacent the transparent cover and drawing the fluid sample into the space between the transparent cover and the substrate by capillary forces. The method further includes dissolving the one or more pillars using the fluid sample, evaporating at least part of the fluid sample to reduce a distance between the transparent cover and the substrate reducing a thickness of the fluid sample, and subjecting the device to analysis to visualize targets in the sample.

In one embodiment of the afore-mentioned method, dissolving the one or pillars and evaporating at least a part of the fluid sample is performed at elevated temperature.

In some embodiments, the analysis is a microscopic, imaging or optical analysis.

In some embodiments, fluid sample includes a biological sample. In some embodiments, the fluid sample also includes a permeabilization buffer, a hybridization buffer, or a combination thereof. In some embodiments, the biological sample includes blood, urine, secretion, sweat, sputum, bronchial lavage, spinal fluid, pus, stool, mucous, or combinations thereof.

In one embodiment, the analysis is to determine the presence of one or more bacteria, yeast or fungi in the fluid sample. In an embodiment, the analysis further includes determining the identity of the one or more bacteria, yeast or fungi.

Another aspect of the invention pertains to a method for loading and thinning a fluid sample for visualization. The method includes providing a device as described herein and loading the fluid sample into the device by depositing the fluid sample on a top surface of the substrate adjacent the transparent cover and drawing the fluid sample into the space between the transparent cover and the substrate by capillary forces. The method also includes dissolving the one or more pillars using the fluid sample, and evaporating at least part of the fluid sample to reduce a distance between the transparent cover and the substrate reducing a thickness of the fluid sample. In some embodiments, dissolving the one or more pillars and evaporating at least part of the fluid sample are performed at elevated temperatures.

Another aspect of the invention pertains to a method of forming a device. The method includes depositing a pillar material in one or more areas on a top surface of a substrate where the pillars are soluble in an aqueous fluid. The method also includes drying the pillar material deposited in the one or more areas thereby forming one or more pillars and bonding a transparent cover to the one or more pillars such that the one or more pillars attach the transparent cover to the substrate. A height of the one or more pillars sets a spacing between the transparent cover and the substrate.

In some embodiments, the pillar solution includes a low molecular weight water-soluble polymer. In an embodiment, the pillar solution includes sucrose. In some embodiments, the pillar solution includes a low molecular weight water-soluble polymer and a water-miscible liquid. In some embodiments, the low molecular weight water-soluble polymer includes a low molecular weight polyvinyl alcohol. In one embodiment, the water-miscible liquid includes a liquid with a high boiling point, a liquid with a low vapor pressure, or a liquid with both a high boiling point and a low vapor pressure. In another embodiment, the water-miscible liquid includes a plasticizer. In one embodiment, the water miscible liquid includes glycerol. In one embodiment, the water miscible liquid includes a phosphorus-containing molecule. In one embodiment, the water miscible liquid includes glycerol and a phosphorous-containing molecule. In one embodiment, the water miscible liquid includes a trialkyl phosphate. In one embodiment, the water miscible liquid includes polyphosphoric acid.

In an embodiment, the method further includes depositing a hydrophobic layer on a top surface of the substrate prior to depositing the pillar material, with the hydrophobic layer including a hydrophobic material with the surface energy of the hydrophobic material being lower than that of the bare substrate. The transparent cover bonded to the one or more pillars at least partially covers the hydrophobic layer and the hydrophobic layer partially covers an area of the top surface of the substrate lying under the transparent cover.

In another embodiment, the method further includes depositing a patterned hydrophobic layer on a top surface of the substrate prior to depositing the pillar material where the patterned hydrophobic layer has a cutout defining a sample loading area on the surface of the substrate and the surface energy of the hydrophobic layer being lower than that of the bare substrate.

In one embodiment, the method further includes depositing a plurality of reagents on a top surface of the substrate at a plurality of testing areas prior to depositing the pillar material, each reagent deposited in a water soluble polymer at a corresponding test area in the plurality of testing areas. In another embodiment, the methods further include depositing a patterned hydrophobic layer on a top surface of the substrate prior to depositing the pillar material, with the patterned hydrophobic layer having a plurality of cutouts corresponding to the plurality of testing areas on the surface of the substrate and the surface energy of the hydrophobic layer being lower than that of the bare substrate.

In one embodiment, the method further includes depositing a first water soluble polymer including a reagent at a test area on a top surface of the substrate prior to depositing the pillar material and depositing a second water soluble polymer over the first water soluble polymer at the test area prior to depositing the pillar material, the second water soluble polymer being more hydrophobic than the first layer of water soluble polymer.

In another embodiment of the method, the one or more pillars are thermally bonded to the transparent cover.

In another embodiment of the method, the one or more pillars are bonded to the transparent cover at room temperature.

In some embodiments, the method further comprises setting an average gap spacing between the transparent cover and the substrate in a range of 40-60 microns during bonding of the transparent cover to the one or more pillars. In some embodiments, the method further comprises setting an average gap spacing between the transparent cover and the substrate in a range of 45-50 microns during bonding of the transparent cover to the one or more pillars.

In some embodiments, the pillar material is deposited in a plurality of areas in a peripheral area of the top surface of the substrate and is deposited in one or more areas in an interior area of the top surface of the substrate and drying the pillar material forms a plurality of peripheral pillars and one or more interior pillars.

In some embodiments, the pillar material comprises polyvinyl alcohol, glycerol and water.

### BRIEF DESCRIPTION OF THE DRAWINGS

The drawings are intended to illustrate the teachings taught herein and are not intended to show relative sizes and dimensions, or to limit the scope of examples or embodiments. In the drawings, the same numbers are used throughout the drawings to reference like features and components of like function.

FIG. 1A depicts a perspective view of a device in accordance with an embodiment.

FIG. 1B schematically depicts a side view of the device of FIG. 1A.

FIG. 1C schematically depicts a top view of the device of FIG. 1A.

FIG. 2 is an image of a patterned hydrophobic layer on a substrate, in accordance with an embodiment.

FIG. 3A schematically depicts loading a fluid sample onto a device, in accordance with an embodiment.

FIG. 3B schematically depicts the device after a fluid sample has been drawn between a transparent cover and a substrate of the device through capillary forces.

FIG. 3C schematically depicts the device after pillars of the device have been dissolved by the fluid sample.

FIG. 4 schematically depicts a multiplexed device for performing ten different PNA assays in accordance with an embodiment.

FIG. 5 schematically depicts different configurations of pillars tested in Example 6.

### DETAILED DESCRIPTION

Some embodiments described herein include a device that enables loading of a fluid sample by capillary action and provides for subsequent thinning of the fluid layer for imaging of the processed sample. Some embodiments of such a device may be used in multiplexed assays. Such a device may be particularly advantageous when employed in FISH assays containing detection probes including, but not limited to, DNA, PNA or LNA probes, e.g. DNA, PNA or LNA FISH assays.

Conventional DNA, PNA or LNA FISH assays require fixing a blood sample on a slide for analysis. The inventors have demonstrated that it is possible to permeabilize microbial cells in a liquid solution sufficiently to allow entry of DNA, PNA or LNA probes and quenchers into the cells. This avoids the need to fix the cells onto the slide in the traditional manner. With solution fixation/permeabilization, in conjunction with a self-reporting (no wash) assay, it becomes possible to use capillary action to fill a slide/coverslip device with a mixture of blood culture and permeabilization/hybridization buffer.

As used herein, the term “probe” means a polymer (e. g., a DNA, RNA, PNA, LNA, chimera or linked polymer) having a probing nucleobase sequence that is designed to sequence-specifically hybridize to a target sequence of a target molecule of an organism of interest.

As used herein, the term “peptide nucleic acid” or “PNA” means any oligomer, linked polymer or chimeric oligomer, comprising two or more PNA subunits (residues), including any of the polymers referred to or claimed as peptide nucleic acids in U.S. Pat. Nos. 5,539,082, 5,527,675, 5,623,049, 5,714,331, 5,736,336, 5,773,571, 5,786,461, 5,837,459, 5,891,625, 5,972,610, 5,986,053, 6,107,470 and 6,357,163. In the most preferred embodiment, a PNA subunit consists of a naturally occurring or non-naturally occurring nucleobase attached to the aza nitrogen of the N-[2-(aminoethyl)] glycine backbone through a methylene carbonyl linkage.

As used herein, the term “locked nucleic acid” or “LNA” means any oligomer, linked polymer or chimeric oligomer, comprising one or more LNA subunits (residues), including any of the polymers referred to or claimed as locked nucleic acids, and nucleic acid analogs in U.S. Pat. Nos. 6,639,059, 6,670,461, United States Patent Application Publication Numbers US2003077609, US2003224377, US2003082807 and International Patent Application Publication Number WO03095467. In some embodiments, a LNA subunit consists of a naturally occurring or non-naturally occurring ribonucleoside in which the 4′ oxygen is joined to the 2′ carbon through a methylene linkage.

Many tests/assays that are visualized on a microscope benefit from making the fluid layer to be examined as thin as possible. A thin fluid layer typically results in lower background and clearer imaging. If the sample includes blood for example, the blood cells and cell contents can obscure microorganisms or other sample components of interest.

Some devices described herein employ capillary action for loading of a fluid sample and incorporate subsequent thinning of the fluid layer for improved imaging of the processed sample. Pillars that dissolve when exposed to a fluid sample enable subsequent thinning of a fluid layer between a substrate (e.g., a microscope slide) and a transparent cover (e.g., a coverslip). Advantages of some devices including soluble pillars are: simplified workflow with fewer components, facile loading of a fluid sample and a buffer; compatibility with familiar microscope slide format; and a self-adjusting fluid layer thickness.

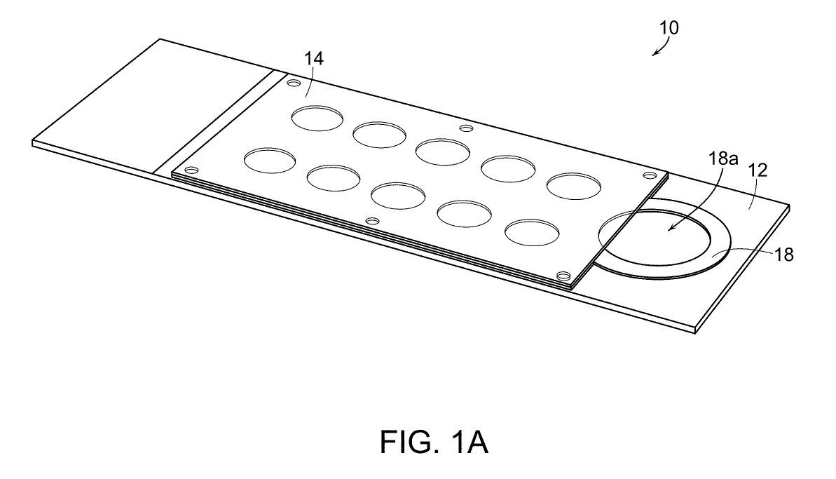

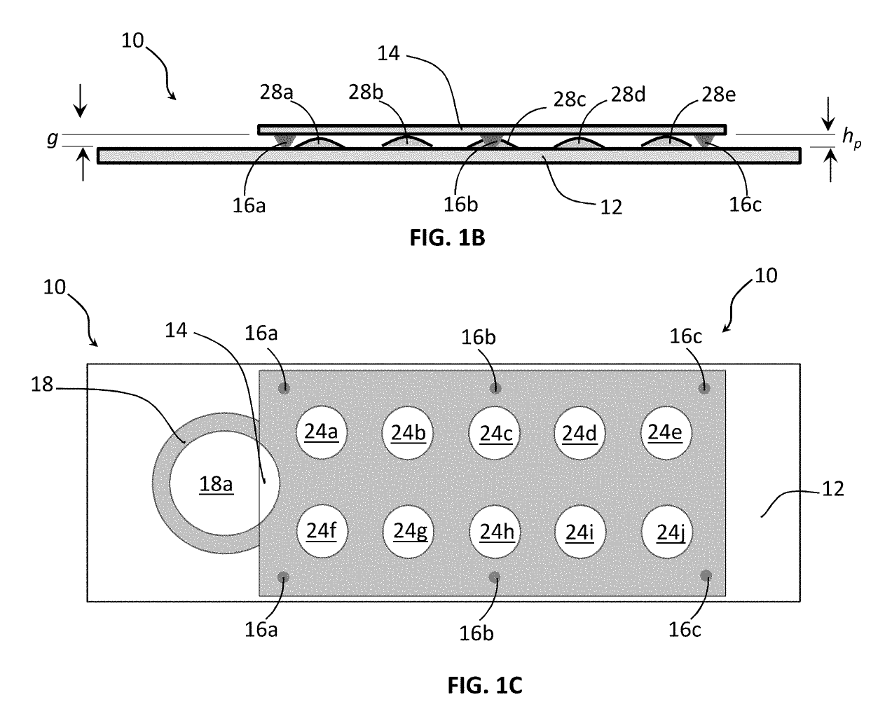

FIGS. 1A-1C schematically depict a device 10 with a substrate 12, a transparent cover 14, and pillars 16a-16f separating the transparent cover 14 from the substrate 12 in accordance with an embodiment. The height hₚ of the pillars 16a-16f set a spacing between the transparent cover and the substrate prior to introduction of a fluid sample to the device 10. A spacing G between the transparent cover and the substrate is configured to draw the fluid sample into a space between the substrate and the transparent cover via capillary forces. In some embodiments, the pillars 16a-16f attach the transparent cover to the substrate prior to introduction of the fluid sample to the device. The material of the pillars 16a-16f is selected to be soluble in the fluid sample. On its introduction into the device, the fluid sample gradually dissolves the pillars 16a-16f, which eventually lose their supportive structure. Thereafter, the thickness of the fluid layer is governed not by the height of the pillars but rather by the volume of fluid trapped between the transparent cover and the substrate. This volume of trapped fluid decreases as fluid evaporates around the perimeter of the transparent cover. The decrease in the trapped fluid volume substantially reduces the thickness of the fluid layer, which improves imaging of the fluid layer.

In some embodiments, the substrate is a slide and the transparent cover is a cover slip. In other embodiments, the substrate and the transparent cover may have other dimensions or configurations. In some embodiments, one or both of the substrate and the transparent cover include a glass. In some embodiments, one or both of the substrate and the transparent cover include a low fluorescent polymer.

In some embodiments, the width of the gap between the substrate and the transparent cover should be configured to enable a fluid sample of sufficient volume to be drawn into the space between the substrate and the transparent cover without leaving significant bubbles or significant areas under the cover slip that are not covered by the fluid sample. In some embodiments, the average spacing between the substrate and the cover falls in the range of 50 to 95 microns. In some embodiments, the average spacing between the substrate and the transparent cover falls in the range of 55 to 85 microns. In some embodiments, the average spacing between the substrate and the transparent cover falls in a range of 60 to 80 microns. In some embodiments, the average spacing between the substrate and the cover falls in a range of 64 to 78 microns. In some embodiments the average spacing between the substrate and the cover falls in a range of 70 to 74 microns.

Desirable characteristics of soluble pillar materials include solubility in the sample/buffer mixture, good adhesion to the surface of the transparent cover and to the surface of the substrate, chemical stability (resistance to chemical change in storage), mechanical stability (lack of creep or flow under storage conditions), and ability to withstand shock and vibration during shipping and handling.

In some embodiments, a material of the pillars includes a low molecular weight water-soluble molecule (e.g., sucrose). In some embodiments, a material of the pillars includes a low molecular weight water-soluble polymer. In some embodiments, a material of the pillars includes a low molecular weight water-soluble polymer and a water-miscible liquid (e.g., a low molecular weight polyvinyl alcohol). In some embodiments, the water-miscible liquid is a liquid with a high boiling point, a liquid with a low vapor pressure, or a liquid with both a high boiling point and a low vapor pressure. In some embodiments, water-miscible liquid includes a plasticizer. In some embodiments, the water-miscible liquid includes glycerol. In some embodiments, the water-miscible liquid includes a phosphorus-containing molecule (e.g., trialkyl phosphate, polyphosphoric acid). In some embodiments, water-miscible liquid includes glycerol and a phosphorous-containing molecule.

Although FIGS. 1A-1C above depict a device with six pillars, one of ordinary skill in the art will appreciate that more or fewer pillars may be employed. In some embodiments, the device includes 1, 2, 3, 4, 5, 6, 7, 8, 9, 10, 11, or 12 pillars. In some embodiments, the device includes between 6 and 30 pillars.

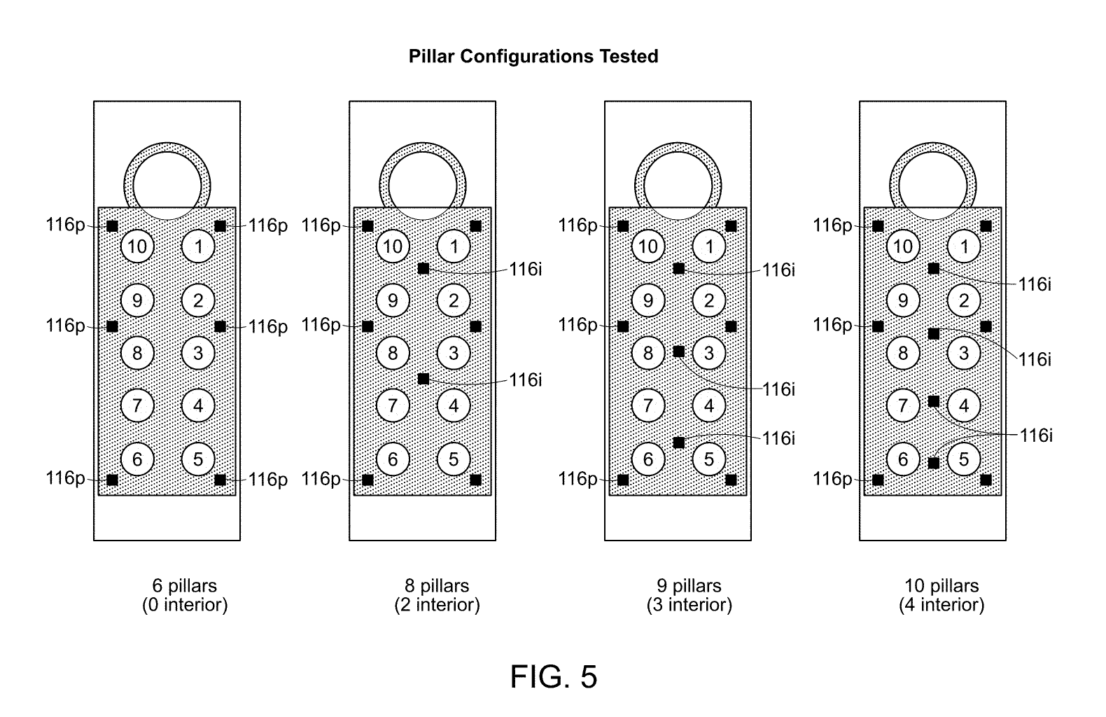

In some embodiments, the device includes a plurality of peripheral pillars 116p disposed around a peripheral area of the device and at least one interior pillar 116i disposed in an interior area of the device (see description of Example 6 below and FIG. 5). In some embodiments in which the device includes a two-dimensional array of testing areas, the at least one interior pillar 116i is disposed between testing areas within the two-dimensional array.

In some embodiments, the device also includes a layer of a hydrophobic material deposited on a top surface of a substrate. Device 10 includes a hydrophobic layer 18 on a top surface 20 of the substrate as shown in FIGS. 1A and 1C. The transparent cover 14 at least partially covers the hydrophobic layer 18. The hydrophobic layer 18 is omitted from FIG. 1B for clarity. Hydrophobic layer 18 has a cutout 18A defining a sample loading area 22 on the top surface 20 of the substrate. The sample loading area 22 is partially covered by the transparent cover 12 and extends on the top surface 20 of the substrate beyond the transparent cover 14. A fluid sample deposited in the sample loading area 22 that lies beyond the transparent cover 14 is drawn into the space between the substrate 12 and the transparent cover 14 by capillary forces. In some embodiments, the hydrophobic layer includes cutouts 24a-24f corresponding to the locations of the pillars 16a-16f. If the hydrophobic layer is continuous, other than cutouts, the cutouts 24a-24f may enable deposition of the pillars 16a-16f onto the top surface 20 of the substrate. In some embodiments, the hydrophobic layer includes a colored material such as an ink so that the hydrophobic layer serves as a visual mask to enable the user or an automated system to navigate the device.

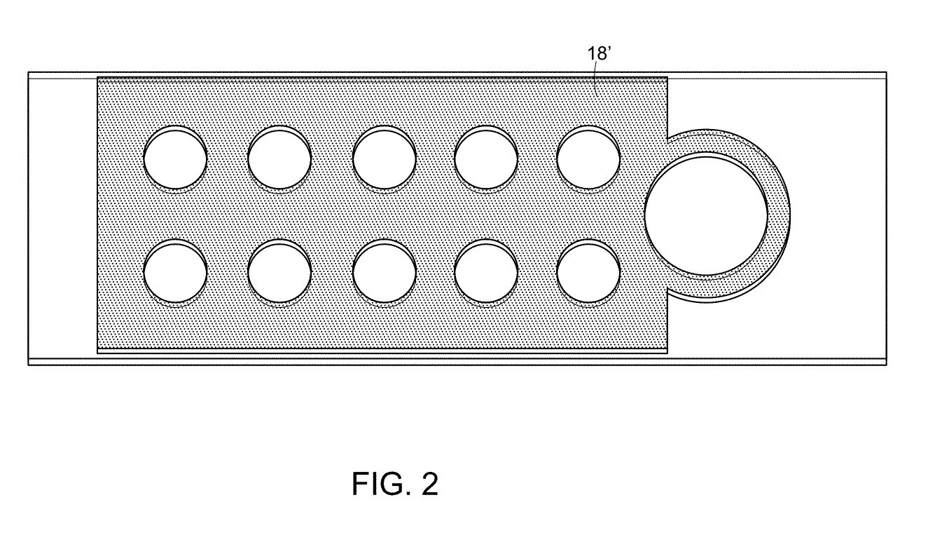

In some embodiments, the hydrophobic layer includes a patterned hydrophobic ink layer and an additional hydrophobic surface treatment. For example, hydrophobic ink layer 18′ in FIG. 2 includes is a halftone layer made up of dots. An additional hydrophobic surface treatment with cutouts for the sample testing areas (not shown) and the pillar deposition areas would be applied over the patterned hydrophobic ink layer 18′ to form hydrophobic layer. In such an embodiment, cutouts would not be needed in the patterned hydrophobic ink layer 18′ for deposition of the pillars because enough of the substrate is exposed through the pattern for the pillars to adhere to the substrate; however, the additional hydrophobic surface treatment would need cutouts corresponding to the pillar deposition areas.

In some embodiments, a device is configured for loading and visualizing a sample without performing an analysis on the sample. In such embodiments, the soluble pillars enable easy loading of a sample through capillary forces and subsequent thinning of the sample for imaging or visualization.

Some embodiments are suitable for assays or tests involving fluid samples. The samples would typically be biological or chemical in nature. Test and control reagents can be disposed on the substrate for reaction with the fluid sample. Some embodiments are particularly suited for tests that include elevated temperature steps such as hybridization. In some embodiments, the device is configured for use in tests or assays involving microscopic examination, imaging, or optical analysis. Examples include Fluorescence in situ Hybridization (FISH) tests and microarray analysis.

In some embodiments, the hydrophobic layer 18 includes one or more cutouts 19a-19j corresponding to one or more testing areas on the top surface 20 of the substrate covered by the transparent cover 14, as shown in FIGS. 1A and 1C. In some embodiments, one or more reagents are disposed at one or more of the testing areas. For example, in device 10, a reagent matrix spot 28a-28j is located at each testing area on the top surface 20 of the substrate, as shown in the side view of FIG. 1B. As noted above, the hydrophobic layer 18 is omitted from FIG. 1B for clarity.

In some embodiments, each testing area includes a first layer of water soluble polymer including one or more of the reagents (e.g., a polymer including poly (vinyl alcohol) and a reagent), and a second layer of water soluble polymer (e.g., a polymer including polyethylene oxide) covering the first layer of water soluble polymer. In the embodiment shown in FIG. 1B, each reagent matrix spot 28a-28j would include a first layer of water soluble polymer including at least one reagent and a second layer of water soluble polymer covering the first layer. In some embodiments, the second layer of water soluble polymer is more hydrophobic than the first layer of water soluble polymer. In some embodiments, the first layer of water soluble polymer includes a hydrophilic polymer. In some embodiments, the one or more reagents are PNA probes. In some embodiments, the one or more reagents are binding agents that bind to at least one microorganism. Further details regarding incorporating reagents in water soluble polymers for multiplexed analyses on substrates can be found in International Patent Application Publication WO 2014/059011 A1 entitled, “Devices, Compositions and Methods Pertaining to Microscopic Analysis of Microorganisms and Other Analytes of Interest,” which is incorporated by reference herein in its entirety.

In Use

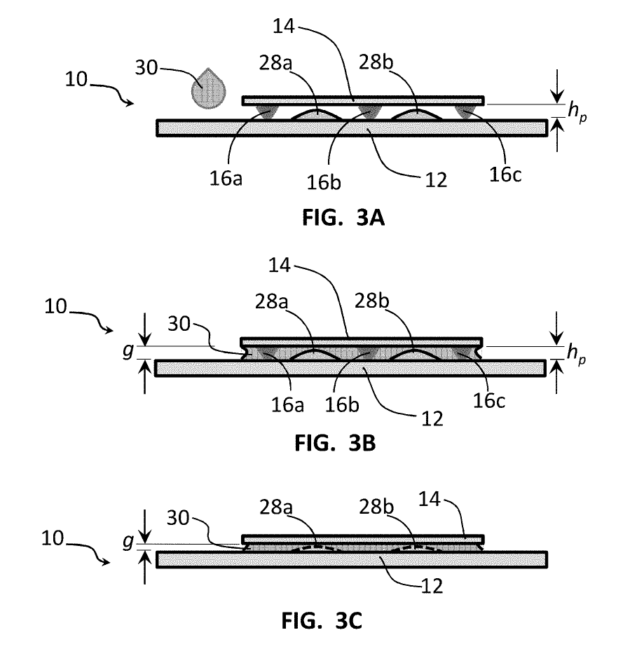

Use of a device in accordance with some embodiments is described below with respect to reference numbers for the device 10 appearing in FIGS. 1A-1C solely for illustrative purposes. A device 10 is provided. In FIGS. 3A-3C, which schematically depict the device 10 in use, hydrophobic layer 18 is omitted for clarity. A fluid sample 30 is loaded into the device 10 by dispensing the fluid sample 30 onto a top surface 20 of the substrate adjacent to the transparent cover 14 (e.g., at the sample loading area 22) (see FIG. 3A). The fluid sample 30 dispensed in the sample loading area 22 on the top surface 20 of the substrate adjacent to the transparent cover 14 is drawn into the space between the transparent cover 14 and the substrate 12 by capillary forces. When the fluid sample 30 is drawn in, the spacing g between the transparent cover 14 and the substrate 12 is determined by the height hₚ of the pillars 16a-16f that attach the transparent cover 14 to the substrate 12 (see FIG. 3B). After the fluid sample 30 is drawn into the space between the transparent cover 14 and the substrate 12, the fluid sample 30 comes in contact with the pillars 16a-16f, which are gradually dissolved by the fluid sample 30. After the pillars 16a-16f are sufficiently dissolved such that they no longer connect the transparent cover 14 and the substrate 12, the transparent cover 14 floats on the fluid sample 30 and the distance g between the transparent cover 14 and the substrate 12 is determined by the volume of the fluid sample between the transparent cover 14 and the substrate 12 (see FIG. 3C). At the same time, the fluid sample 30 at the edges evaporates reducing the volume of the fluid sample, further reducing the distance g between the transparent cover 14 and the substrate 12. The device 10 with the fluid sample 30 between the transparent cover 14 and the substrate 12 can then be used for imaging the fluid sample (e.g., can be viewed or imaged using a microscope).

If the device 10 is being used for analysis, at the same time that the pillars 16a-16f are being dissolved, the fluid sample 30 interacts with one or more reagents disposed on the substrate 12 in the testing areas (e.g., interacts with reagent matrix spots 28a-28j) to process the sample for analysis. The device 10 may be heated or held at elevated temperature while the fluid sample 30 interacts with the one or more reagents. After the fluid sample 30 is processed through interaction with the reagent, the device 10 is subjected to microscopic analysis to visualize the targets of the assay in the processed sample.

The present invention is next described by means of the following examples. However, the use of these and other examples anywhere in the specification is illustrative only, and in no way limits the scope and meaning of the invention or of any exemplified form. The invention is not limited to any particular preferred embodiments described herein. Many modifications and variations of the invention may be apparent to those skilled in the art and can be made without departing from its spirit and scope. The contents of all references, patents and published patent applications cited throughout this application, including the figures, are incorporated herein by reference.

### EXAMPLES

### Example 1: Formation of Pillars and Bonding Pillars to Transparent Cover

The inventors formed pillars on substrates in the form of microscope slides and bonded transparent covers in the form of coverslips to the microscope slides using the pillars. Specifically, pillar material was cast out of solution onto a slide in six bond points to form six pillars. After the pillar material dried, the coverslip was bonded to the pillars through a melt.

Characteristics of desirable pillar materials include the following: that the resulting pillar bonds the substrate to the transparent cover; the bond holds a fixed gap between the substrate and the transparent cover over time; the resulting pillar adhere to the substrate for the shelf life of the device; and the resulting pillar dissolves within a desired timeframe when exposed to a fluid sample and expected conditions, which may include elevated temperature. When the device is meant to be used for analysis that includes hybridization, the pillar material should dissolve within the timeframe and conditions encountered during slide hybridization to ensure proper assay visualization.

The inventors formed pillars using two different combinations of materials. The first combination included polyvinyl alcohol (PVA), glycerol, triethyl phosphate, and water. The second combination included PVA, glycerol, polyphosphoric acid, and water.

A. Pillar Materials Including Triethyl Phosphate—Formulation A

The inventors initially developed formulation A for a pillar material, which is described below. The pillar material was composed of a low molecular weight PVA, 27% w/w solution in water, and glycerol and triethyl phosphate plasticizers. Reagent amounts were adjusted to maximize solubility (minimize solubility time) while maintaining adhesion strength, stability and pillar height. The inventors determined that it was conceptually desirable to have as high as possible level of glycerol and triethyl phosphate versus PVA as the plasticizer components are water miscible and liquid at room temperature, thereby allowing them to drive maximum pillar water solubility.

Inventors' Rationale for Choosing the Reagents
To have as high a water solubility as possible and to make as high a % solids solution as possible to make a dried-down pillar that is at least ˜70 microns high, PVA should have as low a molecular weight with as low a % hydrolysis as is commercially available. 9-10K/80% hydrolyzed PVA from Sigma-Aldrich was chosen.
To have as high a water solubility as possible and to make as high a % solids solution as possible to make a dried-down pillar that is at least ˜70 microns high, the ratio of glycerol and triethyl phosphate should be as high as possible versus PVA
Glycerol was chosen as an effective plasticizer for PVA. A plasticizer for the PVA is also useful because it lowers the melting temperature for bonding.
Triethyl phosphate was chosen as a co-plasticizer for its ability to promote adhesion to glass through perceived noncovalent adsorption between glass surface oxide and phosphorous. It also has a relatively high boiling point and will thereby not significantly evolve during curing or bonding.

Initial Observations

Informal observational testing was conducted to determine qualitatively the effect of glycerol and triethyl phosphate on the pillar material.
Triethyl phosphate increased the pillar solution flowability while causing the dried spot to be rigid.
Glycerol decreased the pillar solution flowability while causing the dried spot to be softer and tackier.
Generally, the dried pillar spot became increasingly compliant and tacky with increasing amount of one or both glycerol and triethyl phosphate.

The inventors used these observations to adjust the composition of the pillar material with the goal of obtaining a pillar material that could produce a desired pillar spot according to the following criteria:
A pillar spot that is tacky enough to serve as an acceptable adhesive and offer sufficient adhesion stability.
A pillar material that flows minimally to build a spot at an appropriate height that will dry to ˜70 microns high.
A pillar spot rigid enough to maintain pillar height integrity versus time.
A pillar spot sufficiently water soluble to dissolve completely during hybridization time.

Two iterations of pillar material (lab scale) were tested:

Pillar formulation #1: 1 g 27% PVA solution in water+0.7 g triethyl phosphate+0.7 g glycerol; and

Pillar formulation #2: 1 g 27% PVA solution in water+0.7 g triethyl phosphate+0.9 g glycerol.

Method of Making Pillar Material, Forming Pillars on Slide Substrates, and Bonding Coverslips

1. Add 1 g 27% w/w PVA in water to vial. PVA solution was made by adding 30 g PVA 9-10K 80% hydrolyzed to 80 mL hot water (preequlibrated to 90° C.), shaken 1 min, then rolled at 90° C. (bottom shelf, oven setpoint 87° C.) for four (4) days. Roller set at 120-500 rpm.

2. Add 0.7 g triethyl phosphate by weight.

3. Add 0.7 or 0.9 g glycerol by weight.

4. Vortex briefly.

5. Put vial in 80° C. oven for ˜1 h.

6. Vortex ˜30 s, invert vial, vortex ˜30 s more.

7. Centrifuge ˜30 s to remove bubbles.

8. Allow to cool to room temp.

9. Add to 1 mL glass syringe and attach needle making sure there are no bubbles.

10. Dispense 0.5 μL solution onto multiplex slide, in 6 positions.

11. Dry/cure on slide moat at 80° C./70 min.

12. Allow to cool completely to room temp.

13. Bond at to coverslip 190° C. on slide bonder for 8 s.

Conclusion

Pillar formulation #2 showed more rapid solubility as evidenced by functional testing in an assay, whereby the test pathogen was visibly flatter than in similar testing with pillar formulation #1. The increased amount of glycerol in pillar formulation #2 did not significantly affect adhesion.

B. Pillar Materials Including Triethyl Phosphate—Formulation B

Further development led to evaluation of several different pillar material compositions including triethyl phosphate, which are labeled as Formulation B. The pillar materials included 1) polyvinyl alcohol (PVA) in its most readily-water-soluble form, (e.g., 80% hydrolyzed, 9-10K molecular weight; 2) glycerol; 3) triethyl phosphate; and 4) water (balance). The compositions of various pillar materials tested appear in Table 1 below in which the ratio in bold identifies the percent ratio of glycerol to triethyl phosphate for each material (e.g., 25/25). In the discussion below, various compositions are labeled by the glycerol weight percentage and the triethyl phosphate weight percentage in the composition (e.g., the 24/14 material refers to a material that is 24% weight percent glycerol and 14 weight percent triethyl phosphate).

The inventors observed in prior experiments that glycerol and triethyl phosphate contribute different but complementary properties to the pillar material: in short, glycerol softens the spot while making the dispensed fluid thicker, while triethyl phosphate hardens the dried spot while increasing the ability of the solution to flow. Thus, the inventors concluded that a 1/1 w/w blend of the two components was reasonable starting point for formulating the pillar material.

Three levels of 1/1 w/w blended material were tested: 29/29, 25/25 and 19/19. Therefore what was tested in these iterations is the amount of total plasticizer. Also tested were two variants where the glycerol/triethyl phosphate is not 1/1: 24/14 and 27/17 glycerol/triethyl phosphate.

TABLE 1
Compositions of pillar materials including triethyl phosphate

| amnt (g) | % | |
|---|---|---|
| | | 29/29 |
| 12 | 11.35% | PVA, 80% hydrolyzed, MW 9-10K |
| 30.84 | 29.17% | glycerol |
| 30.84 | 29.17% | triethyl phosphate |
| 32.04 | 30.31% | water |
| 105.72 | 100.00% | |
| | | 25/25 |
| 12 | 13.33% | PVA, 80% hydrolyzed, MW 9-10K |
| 22.8 | 25.33% | glycerol |
| 22.8 | 25.33% | triethyl phosphate |
| 32.4 | 36.00% | water |
| 90 | 100.00% | Total |
| | | 19/19 |
| 12 | 16.89% | PVA, 80% hydrolyzed, MW 9-10K |
| 13.32 | 18.75% | glycerol |
| 13.32 | 18.75% | triethyl phosphate |
| 32.4 | 45.61% | water |
| 71.04 | 100.00% | Total |
| | | 24/14 |
| 14.4 | 16.95% | PVA, 80% hydrolyzed, MW 9-10K |
| 20.16 | 23.73% | glycerol |
| 11.52 | 13.56% | triethyl phosphate |
| 38.88 | 45.76% | water |
| 84.96 | 100.00% | Total |
| | | 27/17 |
| 17 | 15.15% | PVA, 80% hydrolyzed, MW 9-10K |
| 21.6 | 27.27% | glycerol |
| 13.2 | 16.67% | triethyl phosphate |
| 32.4 | 40.91% | water |
| 79.2 | 100.00% | Total |

To form the pillar material, PVA was first dissolved in water in a roller mixer in an oven for three (3) to four (4) days. Glycerol and triethyl phosphate were then added and the contents were then rolled for three (3) additional hours. The detailed procedure for forming the pillar material is below.

Procedure:
1) Preheat oven such that thermocouple on roller mixer reads 89±1° C.
2) Triple rinse 250 mL Borosilicate glass bottle with water.
3) Add water to glass bottle, cap tightly, and bring to elevated temperature over 30 min.
4) Add PVA, recap bottle tightly, and shake vigorously one (1) minute.
5) Place on mixer roller at 120-500 rpm and roll for three (3) to four (4) days.
6) Add glycerol and triethyl phosphate, shake vigorously, and roll for 3 hours more.
7) Cool to room temperature.
8) Add pillar material to 1 mL glass syringe with needle making sure that no bubbles are present.
9) Set dispense volume to 0.5 μL and dispense rate to 0.88 μL/min on syringe pump.
10) Dispense 0.5 μL pillar material in 6 positions onto multiplex slide.
11) Cure/dry for 70 minutes at 80° C. in oven.
12) Cool to room temperature at least 1 hour in desiccator.
13) Preheat bonding press to 130° C.-150° C. 1 hour prior to use. Bond slide to coverslip at 130° C.-150° C. for 4 seconds.
14) Stack slides and place in desiccator. Monitor adhesion vs. time. Adhesion is noted to have failed when the refractive index by eye is not uniform across the spot, indicating that the bonded material or a portion of the bonded material has detached from either the slide or the coverslip.

Evaluation and Results

Evaluation parameters for the various pillar material compositions were as follows:
1. Adhesion: Pillar must bond slide to transparent cover (e.g., coverslip).
2. Compliance/Gap stability: Bond must hold fixed gap between substrate (e.g., slide) and transparent cover (e.g., coverslip) over time.
3. Dissolution: Pillar material must dissolve within the timeframe and conditions encountered during slide hybridization to ensure proper assay visualization.
4. Adhesion stability: Pillar must adhere for shelf life of device.
5. Pillar solution must be able to be dispensed in an automated fashion.

All pillar material compositions that were tested bonded and adhered the slide to the coverslip. The most dramatic difference encountered appeared in desiccated stability. The 19/19, 24/14 and 27/17 composition variants all showed significant delamination after one week.

The 25/25 pillar material, which included 13.33% PVA, 25.33% glycerol, 25.33% triethyl phosphate, and balance water, showed good adhesion/bonding to the slide and to the coverslip. The 25/25 composition was less compliant than the 29/29 composition and appeared to be able to hold the gap as well as have sufficient adhesion stability.

The 25/25 composition was tested functionally and performed well in functional tests, i.e. the extent of dissolution that took place during hybridization was enough to produce good assay visualization and to promote a working device. The functional test was performed with ecoli/kleb kit and 60 μL 50/50 v/v blood culture/all-in-one (AIO) buffer was dispensed.

The inventors monitored the long term desiccated stability devices formed from the 25/25 composition with respect to adhesion vs. time and bondgap vs. time. The pillars formed with this material held a fixed gap at least two months and maintained adhesion to the substrate and the coverslip for at least two months when stored at room temperature in a desiccator. The pillars formed with this material performed well when used with a functional test ecoli/kleb kit.

C. Pillar Material Including Polyphosphoric Acid

The inventors made and evaluated another pillar material that included polyphosphoric acid instead of triethyl phosphate. The material included PVA (80% hydrolyzed, 9-10K molecular weight); 2) glycerol; 3) polyphosphoric acid; and 4) water (balance). The specific composition of the pillar material appears in Table 2 below.

TABLE 2
Composition of pillar material including polyphosphoric acid

| amnt (g) | | % w/w | Material |
|---|---|---|---|
| 0.545 | | 23 | PVA, 80% hydrolyzed, MW 9-10k |
| 0.2 | | 8.4 | glycerol |
| 0.17 | g | 7.2 | Polyphosphoric acid |
| 1.454 | | 61.3 | water |
| 2.37 | | 100% | Total |

Procedure

The inventors used following procedure in making the pillar material, forming the pillars on a substrate (e.g., a glass slide), and bonding a transparent cover (e.g., a cover slip) to the pillars.

1) Make PVA/water solution:

| amount (g) | reagent |
|---|---|
| 30 | Polyvinyl alcohol, Sigma-Aldrich |
| | #360627, 9-10K MW, 80% hydrolyzed |
| 80 | nuclease-free water |

a) Preheat roller mixer in oven set to 86° C.+/−1° C.
b) Add 80 g nuclease-free water to 250 mL borosilicate glass jar and bring to temperature.
c) Add PVA and shake vigorously for one (1) minute.
d) Allow PVA to dissolve while rolling mixture at 120-500 rpm for four (4) days.

2) Add glycerol and polyphosphoric acid immediately before batching:
a) Add 2 g PVA and water solution to 4 mL glass vial.
b) Add 0.2 g glycerol, cap vial, and heat at 80-85° C. for five (5) minutes. Vortex vial repeatedly to combine. Glycerol is 37.0% w/w to PVA
c) Add 0.17 g polyphosphoric acid to warm PVA/glycerol solution. Vortex vial repeatedly to combine. Polyphosphoric acid is 31.48% w/w to PVA.

3) De-gas via centrifuge as long as needed, usually 30 s will suffice.

4) Transfer a portion to a 1 mL glass syringe such that there are no air bubbles present.

5) Dispense 0.3 uL onto multiplex slide into each of the six (6) pillar positions using syringe pump.

6) Dry on slide warmer at 80° C. for 30 min to 1 hr.

7) Bond slide to coverslip at 190° C. for 8 s.

Preparing this formulation without any glycerol resulted in material turning purplish brown/black, presumably due to dehydration (to polyacetylene) which is not water soluble. Drying the material as formulated for significantly over an hour also resulted in material browning.

Results

The finished pillar material solution was stable for several days. Pillars formed with this material were water soluble, bonded the slide to the coverslip, and held a 50 micro gap between the slide and the coverslip.

### Example 2: Making Multiplex Device with Soluble Pillars

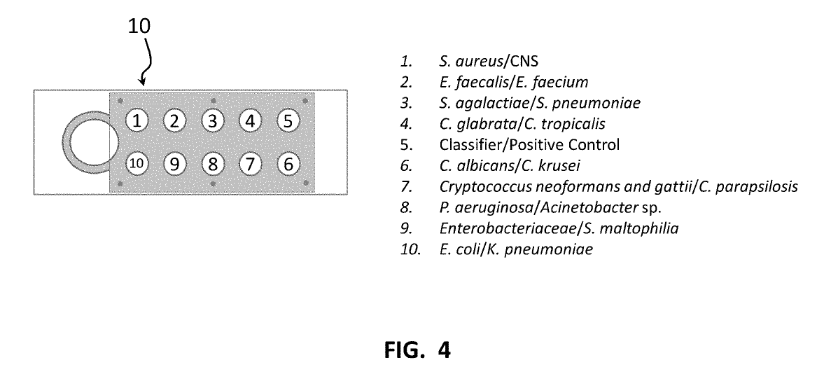

The inventors made a device that included ten different PNA assays. Specifically, the ten different PNA assays included the following: S. aureus/CNS; E. faecalis/E. faecium; S. agalactiae/S. pneumonia; C. glabrata/C. tropicalis; Classifier/Positive Control; C. albicans/C. krusei; Cryptococcus neoformans and gattii/C. parapsilosis; P. aeruginosa/Acinetobacter sp.; Enterobacteriaceae/S. maltophilia; E. coli/K. pneumonia. Reagents in the form of fluorescently-labeled probe and Dabcyl-labeled quenchers for the assays were mixed with a polymer solution, and subsequently the assay reagents and polymer solution mixture was dispensed and cured onto a glass slide in discreet spots, which may be referred to as testing areas. The PNA probes were cured in a water-soluble, hydrophilic polymer and capped with a second layer of polymer which is more hydrophobic than the first. Specifically, the first layer polymer PVA solution was prepared by adding 5 g of polyvinyl alcohol (molecular weight 31-50 k) to 5 ml of nuclease free water and heating in a 90° C. water bath for one hour to dissolve completely. Subsequently, reagents from the ten different PNA assays were separately mixed 1:1 with the polymer solution. 0.5 μL of the assay reagents containing polymer solution for each of the ten assays mixtures was pipetted onto a 25 mm×75 mm×1 mm glass microscope slide. The slide was then cured for an hour in a 70° C. oven. The second layer of polymer PEO solution was prepared by dissolving polyethylene oxide (PEO) (molecular weight 600 k) in dichloroethane to result a 25 mg/ml PEO stock. 1 μL of the PEO solution was spread over each of the cured PVA spots, and then cured again for an hour in a 70° C. oven. FIG. 4 schematically depicts the ten different reagents deposited in polymer on ten different testing areas of the device. The polymers localize the PNA within their spots during use while an biological sample flows across the slide and during hybridization.

A hydrophobic layer was applied to the glass slide in order to match the surface energy of the slide to the surface energy of the second layer of polymer, offering even wetting so that the device can function via capillary filling. For some slides, a hydrophobic ink was printed onto the glass slide to define the sample loading and testing areas. Specifically, CG 142 Emerald Green ink in the Sapphire Series available from Inkcups Now of Danvers, Mass. was used. For some slides, the hydrophobic ink was printed on the glass slide to form a solid layer with cutouts and for other slides it was printed on the glass slide to form a patterned layer with cutouts. The hydrophobic ink layer also served as a mask to enable the user to navigate the device.

For some slides a hydrophobic coating was also applied to the slide using a stamp to modify the surface energy of portions of the slide. There were cutouts on the stamp so that the hydrophobic coating not applied to the testing areas and areas where the pillars would be deposited. Cutouts in the hydrophobic coating defined a sample loading area and testing areas where first polymer containing probes and the second polymer capping layer were deposited. The hydrophobic coating was silicon oil based and selected such that the desired surface energy was obtained.

After deposition of the hydrophobic ink, the first polymer including probes, the second polymer capping layer over the first polymer including the probes, and the hydrophobic coating (when used), pillar solution was deposited in six spots on the glass slide and dried to form six polymer pillars. A glass coverslip was heat-bonded to the polymer pillars at a fixed gap.

Specifically, the glycerol/triethyl phosphate 25/25 formulation of the pillar material, as described in detail in Example 1, was deposited as a solution dissolved in water at around 60% solids. It was deposited in 0.5 μL drops onto the slide via syringe pump. The deposited material was dried in an oven at 80° C. for 70 minutes to evolve the water. The dried material was allowed to cool to room temperature.

For bonding, a transparent cover in the form of a coverslip was placed on a stage heated to between 130° C. and 150° C. The slide containing dried pillars was suspended over the heated coverslip. The slide and heated coverslip were placed in contact using a bonding press for between 4 and 8 seconds. During this time, the pillar material melted and pressure applied to the slide and the coverslip using the bonding press caused deformation of the pillars until the desired gap spacing was achieved and a bond was formed between the slide and coverslip at each pillar. The desired gap spacing was set using a mechanical stop on the bonding press. After the pillar material was melted and the desired gap spacing was achieved the slide and the adherent coverslip were lifted off the heated stage and allowed to cool.

The devices were stored at 2-8° C. in a sealed, foil pouch with or without a desiccant and packed under nitrogen. Devices were removed from the refrigerator and allowed to come to room temperature before opening the packaging in order to avoid condensation on the device.

### Example 3: Multiplex Device with Soluble Pillars Functional Test and Results

Introduction

Capillary filling multiplex blood culture test (MuxBCT) devices were made using a Enterococcus PNA FISH kit. These devices were prepared to test the capability to (1) automate dispensing of all the solutions: (i.e., polyvinyl alcohol (PVA) solution containing probes, polyethylene oxide (PEO) solution, hydrophobic treatment solution (HTS) and pillar solution) and (2) perform functional testing (capillary filling) on a statistically significant number (N=100) of passing devices (devices with an average coverslip distance between 64 and 80 microns). During testing, it was found that a bonded device configuration where the coverslip was tilted with the sample loading area being higher than the far end yielded a high rate of failure and was thereby also considered a failing device. This configuration was noted, marked, and failed, partway through the device qualification. However, this configuration is fixable by adjusting the tilt on the bonding stage.

Device Preparation

Slides were spotted (PVA solution with probe/quencher, PEO solution, HTS, and then pillar solution) with the automated syringe pump/CNC gantry (except for HTS, which was stamped on with stamping wheel). Slides were dried in the oven after the PVA and pillar steps. Slides were stored in desiccator between steps.

Device Production and Evaluation Steps:

A. Print hydrophobic ink layer defining testing areas and sample loading area on slide substrate.

B. Solution Dispense and Dry on slide substrate
1) Polyvinyl alcohol (PVA) containing probe and quencher, and spotting solution, dispense 1.5 μL. The PVA solution was prepared by adding 5 g of polyvinyl alcohol (molecular weight 31-50 k) to 5 ml of nuclease free water and heating in a 90° C. water bath for one hour to dissolve completely. The spotting solution consists of polyethylene glycol, 35K (0.5% w/v), formamide (15.2% v/v), and water (84.3% v/v).
2) Dry 40 minutes in 80° C. oven.
3) Profile PVA layer on several devices.
4) PEO capping layer, dispense 4 μL (allow to dry at room temperature). The PEO solution was prepared by dissolving polyethylene oxide (PEO) (molecular weight 600 k) in dichloroethane to result a 25 mg/ml PEO stock.
5) Profile PEO/PVA layer on several devices.
6) Stamp on hydrophobic treatment solution (HTS) coating.
7) Pillar solution, dispense 0.5 μL. The pillar solution used here is the glycerol/triethyl phosphate 25/25 formulation, as described in detail in Example 1.
8) Dry 70 min in 80° C. oven.
(Store at least overnight and up to one week in desiccator.)

C. Bonding of coverslip to pillars.
9) Check coverslip on optical block. Reject coverslips with significant curvature.
10) Bond slide to coverslip, 150° C. for 4 seconds.

D. Metrology of Bonded Device
11) Measure gap between slide and coverslip using Micro-Epsilon confocal sensing system operating with automated LAB VIEW script/xy-stage. Use Macro in EXCEL to workup the data and calculate the average distance between slide and coverslip.
12) Categorize device based on average gap measurement.

D. Functional Testing
13) Fill devices with 60 μL 1:1 v/v blood culture/AIO buffer the same day as bond. Observe and record filling result. The formulation of the AIO buffer used in this example is listed in below.

All-in-One Buffer

| | |
|---|---|
| NaCl | 0.013M |
| EDTA | 0.007M |
| PEG, 35K | 0.63% |
| Formamide | 37.81% |
| Triton X-100 | 2.1% |
| MgCl₂ | 0.075M |
| Tris, pH 9 | 0.18M |
| CuSO₄ | 0.045M |

14) Pouch, seal, and refrigerate any devices that will not be functionally tested the same day.
15) Hybridize and visualize the slides.

Details of Bonding and Gap Analysis

Bonding was performed at 150° C. for 4 s. Prior to bond, each coverslip was checked on an optical flat block. Most of the coverslips revealed a column spanning the long-side center. Bonded, this coverslip shape gave a long-side bowed appearance. Only relatively flat coverslips were bonded into devices.

Slides with an average distance between 64 and 80 microns were considered a “pass” and pre-flagged “green” indicating they were expected to fill successfully. The goal was to test N=100 of devices perceived to pass in order to successfully qualify the device.

Slides with an average distance between 55 and 63 microns were perceived potentially to fill without failing but were believed to be outside the “comfort zone.” These were flagged “yellow” indicating a “borderline” situation. In real life, these would be screened out as “fail” but were tested for information-gathering purposes. It has been found that the smaller-than-desired gap increases the likelihood of air pocket formation, albeit such air pockets are typically small and on the edge of a testing area, not as to affect the assay. The formation of any air pockets, however, is undesirable as the presence of small air pockets points to the possibility of larger air pockets, which at some point could affect the assay result. Slides with an average distance of less than 55 and greater than 80 microns (too small or too big) were flagged “red” as highly likely to fail.

Air pockets can occur during filling. It is a risk of the capillary filling method. Air pockets occur when the fluid surrounding the polymer-coated testing area moves faster than the fluid in the testing area. When the fluid in the testing area does not catch up during continued filling to the non-polymer surrounding area, an air pocket will be created in an area internal to a testing area, in which there will be no reagent fluid present in the air pocket. No presence of reagent fluid means no signals will be detected in the air pocket region. Therefore, an air pocket that is too large can increase the chance of a false negative result. As such, control of the size of the gap between the substrate and the transparent cover in the device is important to avoid creation of air pockets during use that impair the functionality and reliability of the device.

Details of Device Pre-Analysis and Filling

The bonded devices were arranged, categorized and color-coded. The pre-screen area has several columns in which the total distances between the slide and coverslip was recorded. The “pre-bonded shape” was also pre-screened as pass (green) or fail (red) prior to filling. The “sum” column showed the combination of the area column and the bonded shape column. If either of these failed (red), the sum was fail. Because screening bonded coverslips was relatively new at this stage, the only bonded devices that were actually failed due to shape was the “fail tilt” designation. If the area column was pass (green) but the bonded shape was borderline (yellow), the device passed. As noted, several devices were pre-screened for failure due to the bonded shape but were still counted as failures after filling because the shape metric was initiated for pass/fail in the midst of the device qualification. This way avoided passing failing devices in hindsight. After the bonded devices were pre-screened, preflagged, and categorized, filling for all devices was attempted. Filling (60 μL volume) was performed with a calibrated variable volume pipet (rather than disposable transfer pipet). The entire volume was added to the sample loading area in a single dispense portion (not slowly and continuously as the device fills), at room temperature.

The slides were then hybridized as normal. Slides were then visualized after cooling to room temperature. Description of any air pockets that formed was recorded in an excel file. When air pockets did appear, all bubbles were found in the second-to-last and last row of testing areas, furthest from the sample loading area. Examples of recorded description of air pockets are provided below:

l2bb: last row, 2 big bubbles (meaning 1 bubble each of the two testing areas in a single row. A “big bubble” covers ˜50% of a testing area, the entire device is passed if it is <50%, but failed if it is >50%);

sl1mb: second to last row, 1 medium bubble (a medium bubble covers ˜20% of a testing area);

sl1sb: second to last row, 1 small bubble (a small bubble covers ˜10% of a testing area);

hb: huge bubble: bubble almost entirely or entirely covers a testing area. never occurred on any of the 100 passing devices which were used to obtain data; and

tb: tiny bubble: barely visible, but we're noting it anyway.

Rationale for the Failing Device Metric

A failing device was declared to be one where one testing area had a bubble or air pocket that covered greater than 50% of the testing area. The cutoff at 50% seems large, but it was based on the following rationale:
1) Each testing area is 5.5 mm in diameter.
2) The automated scan area is set at 4 mm² (based on detection limit (LOD) calculations).
3) The area of a testing area, minus a 0.5 mm periphery exclusion zone is (4.5/2)2*π=15.9 mm².
4) This means we are imaging 4/15.9=25% of each testing area.
5) A bubble covering 50% of a testing area still leaves 25% additional space in a testing area to be imaged and maintain the LOD.

Results Breakdown/Summary

Explanation of data collected:
Slides were bonded and examined post-bond and given a “pass” (=flagged green):
   Distance between slide and coverslip must be 64-80 microns;
   Tilted coverslip (largest distance at sample loading are, decreasing down to end) was seen as a risky shape as slides 20, 24 and 26 failed (all showed this common shape), from hereon, all devices having this shape were failed;
   Every other shape was given a pass, even though potentially the visualization would knowingly be affected.
Slides that were rejected post-bond: flagged yellow (“borderline”) or red (“fail”); in real life both of these groups would fail
   Distance was between 55 and 64 microns (flagged yellow—“borderline”);
   Distance is <55 or >80 microns (flagged red—“fail”);
   Bond was clearly tilted due to bonder stage being tilted (unfortunately this metric is difficult to quantify) (flagged red—“fail”).

| | # | % | |
|---|---|---|---|
| pre-filling | 184 | 100% | total number of slides bonded |
| (bonding) | 122 | 66% | amount in “green” (distance only): passing area is 64-80 |
| analysis | | | microns |
| | 104 | 57% | amount “pass” = combination of “green” area plus “green” |
| | | | shape |
| | 50 | 41% | amount “pass” that were of some sort of “tilt” shape |
| | 18 | 15% | amount in “green” (distance only) that failed due to shape |
| | 35 | 19% | amount in “yellow” (distance only) |
| filling | 103 | | number of “passing” slides filled (average distance + |
| results | | | bonded shape) |
| | 100 | 100% | number of passing slides filled minus slides that failed |
| | | | due to being left in open air several days (3 of 3 failed) |
| | 1 | 1% | number that failed with nothing apparently wrong pre- |
| | | | analysis |
| | 5 | 5% | number that failed where the bond was tilted: large at |
| | | | sample loading area, smaller toward end; found to be a |
| | | | shape risky for filling |
| | 6 | 6% | total number of devices that failed |
| | 5 | 5% | total number of near-failures (= one testing area contained |
| | | | a bubble that covered close to 50% of the testing area) |
| | | | *Note: 4 of 5 of these were bonded on high-humidity day |
| | 12 | 34% | amount of “yellow” (average distance only) slides that |
| | | | failed |

Conclusion

The passing rate of the passing bonded devices was 94%. This passing rate consisted of 6 failing devices for the 100 devices tested. Of the 6 devices that failed, 5 had a known risky configuration where the bonded coverslip was tilted with the sample loading area higher than the far end. Thus, the results demonstrate the importance of achieving a gap of 64-80 microns between the substrate and the transparent cover and the importance of the transparent cover not having a significant tilt with the sample loading area higher than the far end.

### Example 4: Multiplex PNA FISH Assay of Blood Culture

The inventors made devices configured for multiplex PNA FISH assays as described in Example 2 above and conducted assays of a blood culture using them.

Formation of Blood Cultures

Bacteria and yeast were grown overnight on agar media at 35° C. One to two colonies were inoculated into 1 ml aliquots of blood culture media with 17% to 20% sterile human blood and incubated at 37° C., shaken or stagnant, for 1.5 to 4 hours in order to generate a mock positive blood culture.

Conducting Assay Using Device

Initially, 175 μl of the all-in-one (AIO) buffer, as described in the Example 3 above, was dispensed into a 1.5 ml gasketed, microcentrifuge tube and stored at 2-8° C. 250 μl of mock blood culture was added to the microcentrifuge tube and it was vortexed. 60 μl of the buffer/blood culture mixture was dispensed onto the device in a sample loading area adjacent to the coverslip. The sample filled the gap between the coverslip and slide by capillary action. The pillars kept the coverslip raised sufficiently high that the sample could flow over the PNA polymer spots rather than around.

The multiplex device with soluble pillars was placed on a 65° C. heat block for 2 minutes and moved to a 55° C. heat block for 15 minutes for hybridization. The soluble pillars began to dissolve within the first few minutes of introducing the sample, allowing the coverslip to float on the surface of the sample. As the device was heated, and the sample began to evaporate, the coverslip settled closer to the slide rather than having the sample pull away from the edges of the coverslip. If instead the sample retracted from the edges of the coverslip because it was stuck on top of pillars, the assays would not have hybridized properly and would not have been interpretable.

The device was removed from the second heat block. Immersion oil compatible with fluorescence microscopy was added to the coverslip over each assay. The assays were visualized in the dark using fluorescence microscopy, a green-red dual band filter, and a 60× oil objective. The thinner gap between the coverslip and slide allowed for improved visualization. Slides with bigger gaps had increased background.

The device was designed such that there would be an algorithm for examining the testing areas which contains different detection kits. Preferably, one testing area which has a classifier function is examined first. The result in this testing area guides the user with regard to which of the other testing areas can be expected to be positive and which can be ignored because they will be negative.

For example, one Multiplex PNA FISH device with soluble pillars contains five different PNA assay mixtures deposited on the slides with the first polymer and the second capping polymer at five distinct locations. Four of the five PNA assay mixtures were based substantially on the Staphylococcus, Enterococcus, GNR Traffic Light and Yeast Traffic Light products available from AdvanDx, Inc. The Gram PNA assay mixture was substantially the same in composition to the commercial products except that the PNA probes were selected to detect gram positive bacteria, gram negative bacteria and yeast. They consist of fluorescein- and carboxytetramethylrhodamine-labeled, PNA probes (some incorporating e-linker solubility enhancing monomers) and shorter, complementary, 4-(dimethylaminoazo)benzene-4-carboxylic acid-labeled quenchers. When examining the slides and interpreting the results, the Gram PNA assay is examined first. The results from this assay are used to determine which assay(s) should be examined next.

Gram PNA: Green Fluorescence—Gram positive bacteria
If cocci in clusters, examine Staphylococcus assay.
If cocci in pairs and chains, examine Enterococcus assay.
Red Fluorescence—Gram negative bacteria
If rods, examine Gram Negative assay.
Yellow Fluorescence—Yeast
If yeast morphology, examine Yeast assay.
No Fluorescence—false positive blood culture

Staphylococcus: Green Fluorescence—Staphylococcus aureus
Red Fluorescence—Staphylococcus epidermidis, capitis, caprae, cohn ii, haemolyticus, or pettenkoferi
No Fluorescence—negative

Enterococcus: Green Fluorescence—Enterococcus faecalis
Red Fluorescence—Other Enterococcus sp. including faecium
No Fluorescence—negative

Gram Negative: Green Fluorescence—Escherichia coli
Red Fluorescence—Pseudomonas aeruginosa
Yellow Fluorescence—Klebsiella pneumoniae
No Fluorescence—negative

Yeast: Green Fluorescence—Candida albicans
Red Fluorescence—Candida glabrata
Yellow Fluorescence—Candida parapsilosis
No Fluorescence—negative

### Example 5: Self-Loading and Auto-Thinning Device for Sample Observation

A device with soluble pillars is manufactured using a slide as described above, except that slide does not contain any detection probes or polymers enclosing detection probes deposited and cured on slide. Specifically, six polymer pillars are deposited and cured to a glass slide. The pillar material formulations are described in Example 1 above. A glass coverslip is heat-bonded to the polymer pillars at a fixed gap from the slide. The produced device can be used for examination of biological samples for different purposes, such as observation of shape and number of microorganisms, cells, particles in a biological sample.

60 μl of a biological sample is dispensed onto the device adjacent to the coverslip. The sample fills the gap between the coverslip and slide by capillary action. The pillars keep the coverslip raised up high enough so that the sample can flow over the slide.

The device is placed on a heat block of 55° C. to 65° C. for a period of time. The pillars begin to dissolve within the first few minutes of introducing the sample, allowing the coverslip to float on the surface of the sample. As the device is heated, and the sample begins to evaporate, the coverslip settles closer to the slide rather than having the sample pull away from the edges of the coverslip.

The device is removed from the heat block. Optionally Immersion oil compatible with particular types of microscopy is added to the coverslip. The device is visualized using microscopy. The thinner gap between the coverslip and slide allows for improved visualization.

### Example 6: Formation of Pillars and Bonding Pillars to Transparent Cover at Room Temperature

The inventors also developed and tested pillar material for room temperature bonding of pillars to the transparent cover (e.g., a coverslip). The inventors noticed that some of the devices made with the pillar material and methods as described in the previous examples had warped coverslips, which caused failure of the devices to be filled uniformly with sample/buffer reagent. Coverslip warping also affected slide assay visualization quality. In high temperature bonding, the cohesive bond strength is low until after the slide and coverslip are removed from heated plate and the apparatus holding the coverslip flat and the pillars cool. Unfortunately, the coverslip can warp after removal from the heated apparatus and before the pillar bond strength is sufficiently high to prevent such warping. In this example, the inventors addressed the issue of coverslip warping using a two pronged approach: the inventors developing a method of bonding at room temperature and employed extra pillars in the interior portion of the device that reduced or eliminated the problem of coverslip warping. In room temperature bonding employed in this example, a vacuum chuck held the coverslip flat during bonding and a nonzero cohesive bond strength developed while the coverslip was held that “locked in place” the flattened coverslip. Adding interior pillars in an interior portion of the coverslip, in addition to peripheral pillars disposed around a peripheral portion of the coverslip reduced the unsupported area of the coverslip and aided in maintaining the desired gap thickness across the coverslip. The inventors tested devices with different pillar materials and various numbers and configurations of pillars bonded at room temperature by pressure bonding, with average nominal gap distance between slide and coverslip ranging between 41-70 microns. The devices with a room temperature bonded gap with nominal average distance ranging between 45-55 microns and with interior pillars, in addition to peripheral pillars, gave excellent results for filling and functional testing. Enterococcus assay (spotted in all wells) looked uniform from well-to-well on these devises. Details are provided below.

Pillar Material for Room-Temperature Bonding

Three pillar material formulations for room-temperature bonding were tested. The first two formulations were prepared starting with the original pillar solution composition (“25/25”, see Example 1, used for high temperature melt bonding) and adding the two water-miscible components, specifically, glycerol and triethyl phosphate in a 1:1 ratio to increase compliance to enable room temperature bonding.

Formulation #1

2 g original pillar material solution (“25/25” from Example 1)+0.1 g glycerol+0.1 g triethyl phosphate

Formulation #2

2 g original pillar material solution (“25/25” from Example 1)+0.2 g glycerol+0.2 g Methyl phosphate

Formulation #3

TABLE 3
Composition of pillar material for room
temperature bonding to coverslip

| amount (g) | % w/w | Material |
|---|---|---|
| 12 | 10.7 | PVA, 80% hydrolyzed, MW 9-10k |
| 37 | 33.0 | glycerol |
| 37 | 33.0 | Triethyl phosphate |
| 26 | 23.3 | water |
| 112 | 100% | Total |

Method

Materials were added to a vial and vortexed. The vials were heated in an 80° C. oven for one (1) hour, then thoroughly vortexed again. The contents were allowed to cool. Slides were spotted using 0.5 pL of pillar solution dispensed via syringe pump in various locations with different numbers and configurations of pillars, specifically, 6 peripheral pillars 116p, 8 total pillars with 6 peripheral pillars 116p and 2 interior pillars 116i, 8 total pillars with 6 peripheral pillars 116p and 2 interior pillars 116i, 9 total pillars with 6 peripheral pillars 116p and 3 interior pillars 116i, and 10 total pillars with 6 peripheral pillars and 4 interior pillars, according to the diagram depicted in FIG. 5.

In order to test the devices functionally, multiplex slides were made as described in the afore-mentioned examples, except for the bonding step. Specifically, an Enterococcus kit was spotted and dried with PVA, a PEO capping layer was spotted and dried at room temperature, HTS was stamped, and the pillar material was applied. The slides were dried at 80° C. for 70 min in an oven then stored overnight in the desiccator. The following day, each slide was bonded to a coverslip at room temperature using the bonding press (4 s bond time with vacuum chuck release valve). Subsequently, 60 pL 1:1 blood culture/AIO buffer reagent fluid was deposited in the slide loading area for functional assay testing and visualization.

Results

When bonded with coverslip at room temperature using pressure bonding, pillar material formulation #2 and formulation #3 worked better than formulation #1, in terms of ability to adhere and hold a warped coverslip flat.

Slides with interior pillars were filled with no air pockets in devices having an average nominal gap distance between slide and coverslip ranging between 45-55 microns. Functional assay visualization of the room temperature bonded slides with interior pillars and a gap of 45-55 microns looked excellent. Visualization was of a high quality and remarkably uniform, both intra- and inter-well as well as from slide-to-slide. Assay visualization quality of this extent had never been obtained with the 6 pillar slide assembly version without any interior pillars. Devices with 8 pillars performed better than devices with 9, 10 or 6 pillars, in filling both functional requirements of uniform filling and holding a warped coverslip flat.

### Example 7: Formation of Pillar Material without Triethyl Phosphate for Bonding Pillars to Transparent Cover at Room Temperature

Another formulation of pillar material for room temperature bonding does not include triethyl phosphate.

TABLE 4
Composition of pillar material without triethyl phosphate for room
temperature bonding to coverslip

| amount (g) | % w/w | Material |
|---|---|---|
| 12 | 10.7 | PVA, 80% hydrolyzed, MW 9-10k |
| 33.6-44.8 | 30-40 | glycerol |
| 66.4-55.2 | 59.3-49.3 | water |
| 112 | 100% | Total |

Devices can be made by room temperature bonding using the pillar material above and employing interior pillars. Such devices may fill uniformly with sample/testing reagent mixture and provide good functional assay visualization quality.

### EQUIVALENTS

In describing embodiments of the invention, specific terminology is used for the sake of clarity. For purposes of description, each specific term is intended to at least include all technical and functional equivalents that operate in a similar manner to accomplish a similar purpose. Additionally, in some instances where a particular embodiment of the invention includes a plurality of system elements or method steps, those elements or steps may be replaced with a single element or step; likewise, a single element or step may be replaced with a plurality of elements or steps that serve the same purpose. Further, where parameters for various properties are specified herein for embodiments of the invention, those parameters can be adjusted up or down by 1/20th, 1/10th, ⅕th, ⅓rd, ½, etc., or by rounded-off approximations thereof, unless otherwise specified. Moreover, while this invention has been shown and described with references to particular embodiments thereof, those skilled in the art will understand that various substitutions and alterations in form and details may be made therein without departing from the scope of the invention; further still, other aspects, functions and advantages are also within the scope of the invention. The contents of all references, including patents and patent applications, cited throughout this application are hereby incorporated by reference in their entirety. The appropriate components and methods of those references may be selected for the invention and embodiments thereof. Still further, the components and methods identified in the Background section are integral to this disclosure and can be used in conjunction with or substituted for components and methods described elsewhere in the disclosure within the scope of the invention.

1. A device comprising:
a substrate;
a transparent cover; and
one or more pillars separating the transparent cover from the substrate, the height of the one or more pillars setting a spacing between the transparent cover and the substrate prior to introduction of a fluid sample to the device.

2. The device of claim 1, wherein the one or more pillars are soluble in aqueous fluids.

3. The device of claim 1, wherein the one or more pillars are soluble in a component of the fluid sample.

4. The device of claim 1, wherein the spacing between the substrate and the transparent cover is configured to draw the fluid sample into a space between the substrate and the transparent cover via capillary forces.

5. The device of claim 1, wherein the average spacing between the substrate and the transparent cover falls in the range of 40 to 95 microns.

6. The device of claim 1, wherein the average spacing between the substrate and the transparent cover falls in the range of 40 to 55 microns.

7. The device of claim 1, wherein the average spacing between the substrate and the transparent cover falls in a range of 45 to 50 microns.

8. The device of claim 1, wherein the one or more pillars attach the transparent cover to the substrate prior to introduction of the fluid sample to the device.

9. The device of claim 1, wherein the one or more pillars comprise a low molecular weight water-soluble polymer.

10. The device of claim 1, wherein the one or more pillars comprise sucrose.

11. The device of claim 1, wherein the one or more pillars comprise:
(a) a low molecular weight water-soluble polymer; and
(b) a water-miscible liquid.

12. The device of claim 11, wherein the low molecular weight water-soluble polymer comprises a low molecular weight polyvinyl alcohol.

13. The device of claim 11, wherein the water-miscible liquid comprises a liquid with a high boiling point, a liquid with a low vapor pressure, or a liquid with both a high boiling point and a low vapor pressure.

14. The device of claim 11, wherein the water-miscible liquid comprises a plasticizer.

15. The device of claim 11, wherein the water miscible liquid comprises glycerol.

16. The device of claim 11, wherein the water miscible liquid comprises a phosphorus-containing molecule.

17. The device of claim 11, wherein the water miscible liquid comprises glycerol and a phosphorous-containing molecule.

18. The device of claim 11, wherein the water miscible liquid comprises a trialkyl phosphate.

19. The device of claim 11, wherein the water miscible liquid comprises polyphosphoric acid.

20. The device of claim 1, further comprising a hydrophobic layer deposited on a top surface of the substrate, the hydrophobic layer comprising a hydrophobic material, the transparent cover at least partially covering the hydrophobic layer.

21.-78. (canceled)
